(19) United States
(12) Patent Application Publication
(10) Pub. No.: US 2010/0299213 A1
(43) Pub. Date: Nov. 25, 2010

(54) System and method for providing internet based advertising in a retail environment

(76) Inventor: Shervin Yeganeh, East Norwich, NY (US)

Correspondence Address: DILWORTH & BARRESE, LLP, 1000 WOODBURY ROAD, SUITE 405, WOODBURY, NY, 11797, US

(21) Appl. No.: 12/454,669

(22) Filed: May 21, 2009

(51) Int. Cl. G06Q 30/00; G06F 17/30; H04W 4/12

(52) U.S. Cl. 705/14.71; 705/26; 455/466; 707/E17.044

(57) ABSTRACT

A system for providing information about an item to a customer. The system comprises a first processor effective to receive a first request from an electronic device regarding an item, the electronic device and the item both being disposed inside a store; a second processor connected to the first processor and effective to receive the first request and generate at least one keyword relating to the first request; and a third processor connected to the second processor and effective to receive the keyword, convert the keyword into a second request and forward the second request to a search engine. The third processor is further effective to receive least one advertisement from the search engine, the advertisement relating to the second request. A fourth processor is connected to the third processor and is effective to receive device information and the advertisement, the fourth processor effective to convert the advertisement based on the device information to produce a formatted advertisement; and wherein the first processor is effective to receive and forward the formatted advertisement to the electronic device.

### BACKGROUND OF THE INVENTION

1. Field of the Invention

This disclosure relates to advertising systems and, more particularly, to a system that can provide Internet based advertising in a retail environment.

2. Description of the Related Art

Advertisers desire to send their advertising resources to intended audiences. Internet based online advertising systems generally involve a customer querying a search engine with keywords (for example the keywords “LCD TV”), the customer reviewing the results of the search as well as sponsored links from advertisers appearing on the same page as the results, and then the customer clicking on one of the sponsored links. In effect, the consumer has expressed his intention twice—first with his query, then with his click.

Advertisers can bid for keywords in an online auction so their respective advertisement can be displayed with search results in response to certain keywords. Other online advertising models charge when a displayed coupon is printed or when a displayed telephone call is dialed. Models are used by search engines to allow them to know more about how many users click on advertisements and subsequently go on to complete a purchase.

Search engines may use a cost-per-click pricing model where the search engine charges an advertiser every time a customer clicks on the advertiser's advertisement. Advertisers may also pay a fee for each number (e.g. 1000) of times their advertisement is displayed on a customer's computer. This disclosure describes an improvement on these prior art technologies.

### SUMMARY OF THE INVENTION

One embodiment of the invention is a method for providing information about an item to a customer, the method comprising receiving a first request from an electronic device, regarding an item, at a first processor, the electronic device and the item both being disposed inside a store; generating, at a second processor connected to the first processor, at least one keyword relating to the first request; converting, at a third processor connected to the second processor, the keyword into a second request; forwarding, at the third processor, the second request over the Internet to a search engine; receiving, at the third processor, at least one advertisement from the search engine relating to the second request; receiving, at a fourth processor connected to the third processor, device information and the advertisement; converting, at the fourth processor, the advertisement based on the device information to produce a formatted advertisement; receiving the formatted advertisement at the first processor; and forwarding the formatted advertisement from the first processor to the electronic device.

Another embodiment of the invention is a system for providing information about an item to a customer, the system comprising a first processor effective to receive a first request from an electronic device regarding an item, the electronic device and the item both being disposed inside a store; a second processor connected to the first processor and effective to receive the first request and generate at least one keyword relating to the first request; a third processor connected to the second processor and effective to receive the keyword, convert the keyword into a second request and forward the second request to a search engine; the third processor further effective to receive least one advertisement from the search engine, the advertisement relating to the second request; a fourth processor connected to the third processor and effective to receive device information and the advertisement, the fourth processor effective to convert the advertisement based on the device information to produce a formatted advertisement; and wherein the first processor is effective to receive and forward the formatted advertisement to the electronic device.

Yet another embodiment of the invention is a method for providing information about an item to a customer, the method comprising receiving a request from an electronic device, regarding an item, at a first processor, the electronic device and the item both being disposed inside a store; generating, at a second processor connected to the first processor, at least one keyword relating to the request; converting, at a third processor connected to the second processor, the keyword into a request; forwarding, at the third processor, the request over the Internet to a search engine; receiving, at the third processor, at least one alternate price or customer review from the search engine relating to the request; receiving, at a fourth processor connected to the third processor, device information and the advertisement; converting, at the fourth processor, the alternate price or customer review based on the device information to produce a formatted alternate price or customer review; receiving the formatted alternate price or customer review at the first processor; and forwarding the formatted alternate price or customer review from the first processor to the electronic device.

Still yet another embodiment of the invention is a method for providing information about an item to a customer, the method comprising receiving, at a first processor, at least one keyword regarding an item from an electronic device, the electronic device and the item both being disposed inside a store; converting, at a second processor connected to the first processor, the keyword into a request; forwarding, at the second processor, the second request over the Internet to a search engine; receiving, at the second processor, at least one advertisement from the search engine relating to the request; receiving, at a third processor connected to the second processor, device information and the advertisement; converting, at the third processor, the advertisement based on the device information to produce a formatted advertisement; receiving the formatted advertisement at the first processor; and forwarding the formatted advertisement from the first processor to the electronic device.

### BRIEF DESCRIPTION OF THE DRAWINGS

The drawings constitute a part of the specification and include exemplary embodiments of the present invention and illustrate various objects and features thereof.

FIG. 1 a system drawing of an Internet based retail advertising system in accordance with an embodiment of the invention.

FIG. 2 is a system drawing an advertising transaction system which could be used in accordance with an embodiment of the invention.

FIG. 3 is a flow chart illustrating a process which could be performed in accordance with an embodiment of the invention.

FIG. 4 is a flow chart illustrating a process which could be performed in accordance with an embodiment of the invention.

FIG. 5 is a system drawing of an Internet based retail advertising system in accordance with an embodiment of the invention.

FIG. 6 is a system drawing an advertising transaction system which could be used in accordance with an embodiment of the invention.

FIG. 7 is a flow chart illustrating a process which could be performed in accordance with an embodiment of the invention.

FIG. 8 is a flow chart illustrating a process which could be performed in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a limitation on the scope of the invention. In addition, an aspect described in conjunction with a particular embodiment of the invention is not necessarily limited to that embodiment and can be practiced in conjunction with any other embodiments of the invention.

The inventors have discovered that because many purchases are made in tangible retail stores, Internet based advertising and search service providers like GOOGLE miss a big opportunity to reach out to customers who purchased or express an interest to purchase an item in these retail stores.

The inventors further realized that providing advertising in retail stores based on a set of variables such as purchased item information, purchased items history, location of the point of purchase, type of the store and other variables such as specific time periods and using the power of the Internet based advertising engines would make advertising less wasteful and its value more measurable.

Similarly, retailers and merchants do not have effective and profitable advertising systems on their retail systems. Some of them may use a local advertising engine which may have access to very limited advertisers. Many of these retail advertising engines display static content or print promotions on customer receipts regardless of the customer interests or purchased items. As the source of the advertising contents is limited and the cost of maintaining them is considerable, these advertisements may not derive higher sales nor profits.

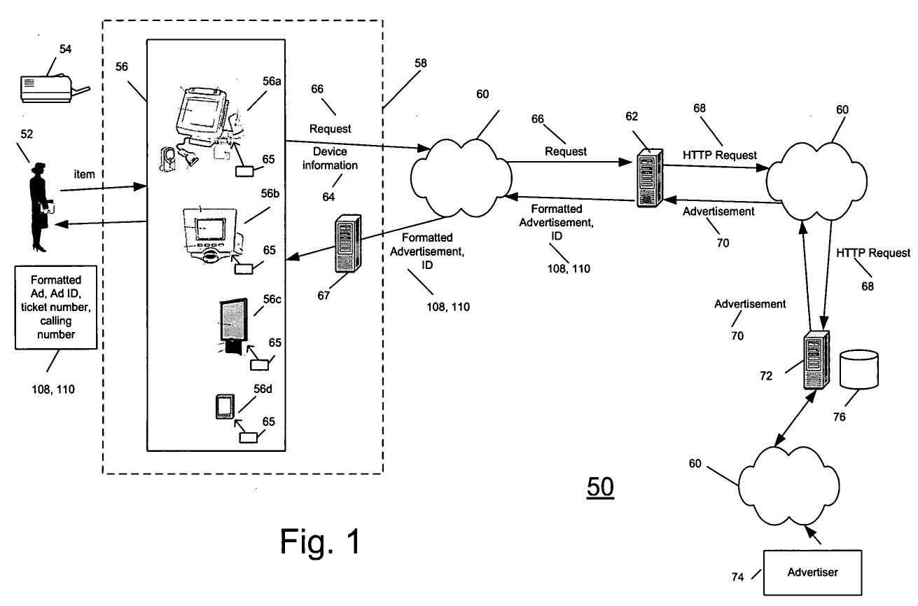

Referring to FIG. 1, there is shown a system 50 in accordance with an embodiment of the invention. In system 50, a customer 52 generates a request at an electronic device 56 disposed in a store 58 regarding an item of interest 54 also disposed in store 58. Electronic device 56 may be located at, for example, a retail store. Electronic device 56 may be an electronic payment device 56a where customer 52 desires to purchase item 54. Electronic payment device 56a receives the bar code of item 54 and handles payment and printing receipt functions. Electronic payment device 56a could be operated as a standalone self-service checkout device or cashier operated and may include a display screen and a printer.

Electronic device 56 may also be an interactive information station 56b where customer 52 searches and reviews information about product 54 including locations of product 54 in store 58. An interactive information station 56b may have an optical scanner for reading a product barcode on item 54 to display the product price and other related information. For example, customer 52 may want to find information such as the location, price or specification of item 54 by using interactive information station 56b. Customer 52 may conduct the search using search keywords, the barcode, or a directory service (category, type, aisle, etc.). By conducting the search, product and service information would be retrieved and displayed by electronic device 56b. Electronic device 56b may display other related items/services. Electronic device 56b may be equipped with a touch screen display monitor to allow customer 52 to select an item on the screen by touching the specific area. Interactive information station 56b may be equipped with a printing device that allows printing promotions and coupons based on a customer request. Advertising contents may also be displayed on the display. The advertisement could be simple text, image, or multimedia video/audio.

Electronic device 56 may be an electronic billboard 56c installed inside or outside of store 58. Electronic billboard 56c may be a flat display screen on which large advertisements or notices are posted. Electronic billboards 56c can be interactive which allows a customer to input information (usually through a touch screen display interface) and to get extra information regarding advertised content. In an informative billboard, there is generally no direct interaction between store visitors and the electronic device. The cost of the advertising is usually calculated based on the estimation of the number of store visitors that may view the billboard at the specific period of the time. In an interactive billboard, visitors may interact with the device usually through its touch screen display interface. Based upon the programmed functionality, visitors may write a note using a stylus pen or select an advertised item to acquire more information.

The display screen could be a touch LCD screen. Customer 52 can interact with the interactive billboard 56c by touching designated areas of the display screen. For example, the customer can write a note on the screen, or he/she can select an advertised item for more information.

Electronic device 56 may be a cell phone or contact-less card 56d. Registered customers may place a contact-less chip or cell phone 56d equipped with RFID (radio frequency identification) in the proximity of a RFID reader in any of electronic devices 56a, 56b, 56c to receive advertisements or additional information (as described below). Customer 52 may also use his cell phone 56d to send a text message regarding item 54. For example, item 54, formatted advertisement 110 (discussed below), or formatted additional information 210 (discussed below) may include a number which can be used to generate a text message about item 54. Customer 52 may also send a text message from cell phone 56d about item 52 requesting alternate prices or customer reviews about item 54.

Each electronic device 56 includes a piece of software 65 effective to generate and forward a request 66 including information about item 54, from electronic device 56 in store 58, over a network 60 such as the Internet, to an advertising translation system 62. Cell phone 56d may simply generate a text message. Advertising translation system 62 converts request 66 to produce an HTTP request 68. For example, keywords relating to item 54 may be added by advertising translation system 62 (as is discussed in more detail below). HTTP request 68 is sent to a search engine such as an online advertising server, or coupon search engine 72 (e.g. GOOGLE, YAHOO!, NET, PRICEGRABBER, etc). Online advertising server, search engine, or coupon search engine 72 searches a database 76 for advertisements 70 relating to HTTP request 68. Advertisements 70 may have been provided by an advertiser 74 through, for example, network 60 and may include promotional items like coupons, text, multi-media, etc. Online advertising server 72 may also search database 76 for alternate prices or customer reviews of item 54.

Online advertising server 72 forwards advertisement 70 to advertising translation system 62 over Internet 60. Advertising translation system 62 receives advertisement 70, and converts advertisement 70 to produce a formatted advertisement 110 in a format that can be displayed or printed by electronic device 56. Formatted advertisement 110 is sent over network 60 to store 58 and electronic device 56 and then displayed or printed for customer 52.

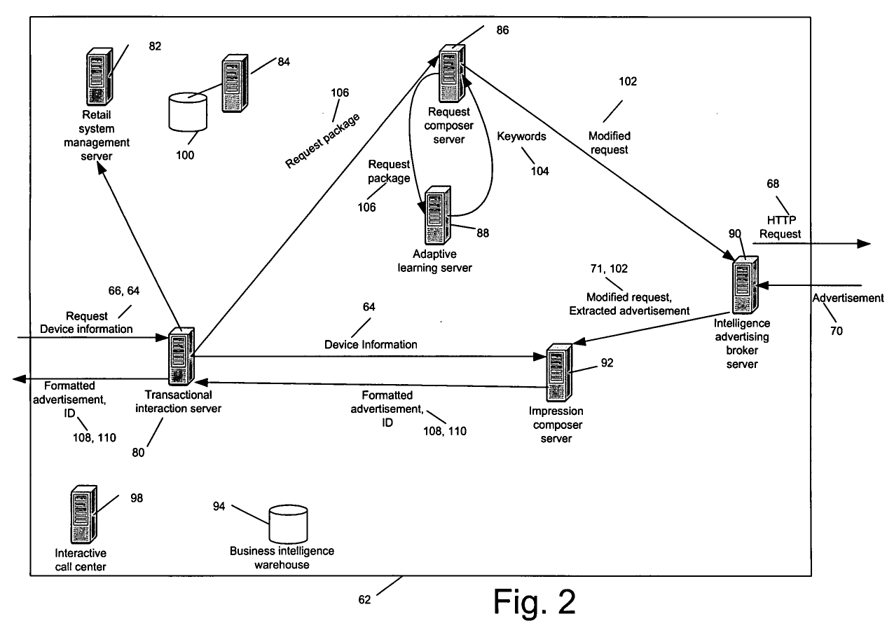

A more detailed explanation of advertising translation system 62 is shown in FIG. 2. Referring to FIG. 2, advertising translation system 62 may include a transactional interaction server 80, a retail system management server 82, an information database server 84, a request composer server 86, an adaptive learning server 88, an intelligence advertiser broker server 90, an impression composer server 92, an interactive call center 98, and a business intelligence warehouse 94.

Transactional interaction server 80 manages communication with electronic devices 56. Electronic devices 56, perhaps in a retail store 58, may communicate with transactional interaction server 80 using a communication protocol over network 60. Transactional interaction server 80 handles and converts multiple different communication protocols based upon electronic device 56. For example, transactional interaction server 80 converts from Internet Protocol messages such as TCP (transfer connect protocol), HTTP (hypertext transfer protocol), SHTPP (secure hypertext transfer protocol), etc. or SMS (short messaging service) messages used by cell phone 56d, to XML (extensible markup language) messages.

Transactional interaction server 80 is responsible for a) security and authentication of electronic device 56, b) registering of new electronic devices 56 c) converting messages from electronic devices into a format used by advertising translation system 62 (e.g. XML), and d) converting formatted advertisements received from impression composer server 92 (discussed below) into the communication protocol used by electronic device 56.

Retail system management server 82 maintains registrations of electronic devices 56. For example, account numbers, addresses, store location, type, etc. can be managed by retail system management server 82.

Information database server 84 serves as the local database server to a database 100 and provides for storing and retrieving of information for advertising translation system 62. Some examples of information handled by information database server 84 include information regarding registered electronic devices 56, authentication information, search keywords, barcode information (i.e. item names corresponding to barcodes) and items associations (i.e. additional keywords that can be added to items).

Request composer server 86 receives a request package 106, which basically comprises request 66 and an identification of electronic device 56 from transactional interaction server 80 and uses adaptive learning server 88 to generate a modified request 102 including keywords 104 to forward to online advertising server 72.

Adaptive learning server 88 is a self-optimized keywords factory engine. Adaptive learning server 88 generates keywords 104 for item 54 to be used by online advertising server 72. Adaptive learning server 88 can, for example, forward the barcode of item 54 in request 66 to information database server 84 to yield the associated item name stored in database 100. The item name may then be used as part of the keywords 104. Adaptive learning server 88 may generate additional keywords. For example, if request 66 includes barcode# 123456789012, adaptive learning server 88 may find from information database server 84 the associated item name e.g. ‘Samsung Plasma TV 52 inch HD-4253’. Adaptive learning server 88 may then generate the keyword “accessory” based on items associations in database 100. Adaptive learning server 88 adds “accessory” to keywords 104 and request package 106. Keywords 104 could include, for example, the word “price” if customer 52 is requesting alternate prices for item 54. Request composer server 86 generates modified request 102 and forwards modified request 102 to intelligence advertising broker server 90.

Intelligence advertising broker server 90 is a gateway component that communicates with Internet based online advertising server 72 via network 60. Intelligence advertising broker server 90 receives modified request 102 from request composer server 86 in, for example, XML format, and converts modified request 102 into an HTTP request 68 in, for example, HTTP format. HTTP request 68 is forwarded to online advertising server 72 (FIG. 1). Online advertising server 72 consults database 76 for advertisements, alternate prices or customer reviews relating to HTTP request 68. Advertisements 70 returned from online advertising server 72 are converted by intelligence advertising broker server 90 into a format (e.g. XML) used by impression composer engine server 92. As intelligence advertising broker server 90 may work with several Internet based online advertising servers 72, intelligence advertising broker server 90 selects the particular online advertising server 72 based upon several parameters like the requested advertisement type based on device information 64 (to be displayed, to be printed, coupons, . . . ), cost per advertisement, retail store type, etc.

For example, intelligence advertising broker server 90 selects online advertising server 72 based on a category of the request in request package 106 and an advertising service provider score.

The category of a request is determined based on four parameters:

Request Type: e.g. ads delivered for impression (like brand name, logo, . . . ), promotion, coupons, alternate price, customer review, ads-for-phone call, ad detail information, etc.

Media Type: text, image, multi-media.

Electronic device 56: e.g. a electronic payment device at checkout lane, interactive information station, electronic billboard, phone.

Action: display, print, select, sale.

Internet based online advertising service providers are grouped based upon the request categories they can support. For example GOOGLE, YAHOO!, and MICROSOFT support ads-to-display and ad-to-be-selected or clicked in text, image and multimedia format. In other words they support cost-pet-click (CPC) and cost-per-impression (CPI) only. RetailMeNot and Coupons2buy provide online coupons and promotions to be printed. CNET provides a customer review service and PRICEGRABBER provides price comparison services.

A score is assigned to each online advertising server 72 by intelligence broker server 90 based upon certain parameters such as existing records of the payment rate per request category (cost per advertisement), response time, and customers' feedback on advertised items. The online advertising server 72 with the highest score in the group may be selected by intelligence broker server 90.

Impression composer server 92 converts advertisement 70 received from intelligence advertising broker server 90 into a format that can be displayed or printed on electronic device 56 based on device information 64 received from transactional interaction server 80 and modified request 102, i.e., not in HTML format. For example, if advertisement 70 is an image in size that is larger than the advertisement area on the display screen of electronic device 56, impression composer server 92 resizes the image to the proper size. Impression composer server 92 may change the object format of the advertisement. For example, if electronic device 56 can only display TIFF file format and the returned content is in GIF format, impression composer server 92 converts advertisement 70 from GIF to TIFF. Impression composer server 92 produces a formatted advertisement 110 and advertisement ID 108 that are sent to transactional interaction server 80 to be returned to electronic device 56. Store 58 may have the option of filtering formatted advertisement 110 using a processor 67 so that formatted advertisement 110 is not displayed on an electronic device 56. For example, processor 67 may look for words including the name of competitors in formatted advertisement 110.

Business intelligence warehouse 94 records all significant events and processes including their date and time for further analysis. Business intelligence warehouse 94 constantly analyses input records and information to acquire a better understanding of the commercial context. Common functions of business intelligence warehouse 94 are reporting, OLAP (online analytical processing), data mining, predictive analysis, customer purchases analysis, and impression history analysis. Some examples of events recorded are: date and time of communication of receipt of request 66, request 66, outputs of request composer server 86 and impression composer server 92, etc. Business intelligence warehouse 94 also provides vital information regarding the performance of system 62 like the round trip time from receiving a request 66 to returning a formatted advertisement 108.

Interactive call center server 98 is an automated call center for answering telephone calls from customer 52 such as calls regarding printed advertisements on the customers' receipt. This service may address a cost-per-call advertising model. One of the forms of advertising is printing a phone number of advertiser 74 on a receipt of customer 52. The customer may call the advertiser 74 using the phone number printed on his/her receipt. The phone number presented on the receipt is a toll-free phone number of the interactive call center server 98. Interactive call center server 98 automatically answers the phone, asks the customer to enter a ticket number (described below) and advertisement identification number 108. The customer enters the numbers using the phone keypad numbers or he/she can say the number for use by voice recognition technology. Interactive call center 98 uses this information to identify a phone number of advertiser 74 of formatted advertisement 110 from business intelligence warehouse 94. Using the phone number of advertiser 74, interactive call center server 98 forwards the call from customer 52 to advertiser 74.

The following describes an example of the use of system 50 where information about an item in the form of an advertisement is delivered to a customer. Starting with FIG. 1, customer 52 brings item 54 to electronic payment device 56a in store 58. An operator of electronic device 56a enters information about item 54. For example, a cashier scans the barcode number of item 54 using an optical barcode reader. Software 65 then forwards request 66, including information about item 54 and device information 66, to advertising translation system 62. Request 66 may also include information about customer 52 such as his name, the last 4 digits of his credit card number, etc. Device information 64 may include, for example, a number of text lines available for printing by electronic device 56, display information of electronic device 56 such as size of the advertisement area, image types, printer specifications, etc. An identification of store 58 may also be included in request 66 such as the store name, store location, local time, business type, store ID, etc.

Referring now to FIG. 2, when transactional interaction server 80 receives request 66 and device information 64, transaction interaction server 80 assigns a unique ticket number to request 66 and stores a record of request 66 in business intelligence warehouse 94 including date and time, ticket number, an identification of store 58 including store location and type and request 66. The identification of store 58 and device information 64 may similarly be sent in request 66 or stored in business intelligence warehouse 94.

If not provided by store 58, transactional interaction server 80 may obtain device information 64 from retail system management server 82. Device information 64 is used by impression composer server 92. Transactional interaction server 80 converts request 66 into XML format and creates request package 106 including the ticket number, identification of store 58, device information 64, and request 66. Transactional interaction server 80 forwards request package 106 to request composer server 86.

Request composer server 86 sends request package 106 to adaptive learning server 88 to generate keywords 104 using the provided item information in request 66 (for example the barcode). Adaptive learning server 88 analyzes request package 106 and retrieves keywords 104 from information database server 84. Adaptive learning server 88 may identify additional keywords 104 in database 100 based upon request 66, device information 64 and other parameters such as an identification of store 58. For example, adaptive learning server 88 may use parameters such as: an item's full name, item category (e.g. electronics, hardware, tools, etc.), item manufacturer, retail business category (e.g. hardware store, electronics, etc.), retail name, location, language, item's dependency tree (accessory types, reusable, consumable, etc.), customer feedback data on displayed advertisements for similar items, price, etc. Alternatively, keywords 104 may have been sent from electronic device 56.

Adaptive learning server 88 sends keywords 104 to request composer server 86. Request composer server 86 generates modified request 102 for intelligence advertiser broker server 90 including the ticket number, store identification, device information, request 66, and keywords 104. Request composer server 86 sends modified request 102 to intelligence advertising broker server 90. Intelligence advertising broker server 90 determines which online advertising server 72 (FIG. 1) is to be used based upon several parameters as discussed above. Intelligence advertising broker server 90 then converts modified request 102 including keywords 104 to HTTP (hypertext transfer protocol) formatted request 68 and sends HTTP formatted request 68 to the selected online advertising server 72. Intelligence advertiser broker server 90 stores HTTP request 68 in business intelligence warehouse 94 (e.g. date and time, ticket number, store identification, device information, request 66, keywords 104, selected online advertising server 72, and HTTP request 68).

Focusing on FIG. 1 again, Internet based online advertising server 72 processes HTTP request 68, consults a database 76 which may include advertisements provided by at least one advertiser 74, alternate prices or customer reviews and returns this data (advertisements 70 are shown as examples, but it should be clear that the description of advertisements applies equally to alternate prices or customer reviews) to advertising translation system 62 relating to HTTP request 68. At advertising translation system 62 (FIG. 2), intelligence advertising broker server 90 may extract advertising content 71 from advertisement 70 (or alternate prices or customer reviews) including the advertiser's URL, contact phone number, advertisement text, color, image, audio, etc. and sends extracted advertising content 71 and modified request 102 to impression composer server 92. For example, intelligence advertising broker server 90 may extract paragraphs of advertisement 70 with the most matching keywords. Impression composer server 92 converts extracted advertisement content 71, based on device information 64 received from transaction interaction server 80, to a formatted advertisement 110 in a format that is suitable for electronic device 56 to display or print. Impression composer server 92 assigns a unique advertisement ID number 108 to each formatted advertisement 110. Advertisement ID 108 may be displayed or printed with formatted advertisement 110 on electronic device 56. Impression composer server 92 may store formatted advertisement 110, and information about advertiser 74 including its phone number, in business intelligence warehouse 94. Impression composer server 92 notifies adaptive learning server 88 of formatted advertisement 110 to enable further future analysis by adaptive learning server 88. Adaptive learning server 88 uses this information to adjust the keyword generation processes.

Impression composer server 92 sends formatted advertisement 110 and advertisement ID 108 to transactional interaction server 80. Transactional interaction server 80 converts formatted advertisement 110 and advertisement ID 108 into a format that can be communicated over network 60 (such as using an Internet Protocol or SMS) and forwards (FIG. 1) formatted advertisement 110 and advertisement ID 108 to electronic device 56 over network 60 for display and/or printing on electronic device 56. Advertisement 110, along with advertisement ID 108, the ticket number and a calling number may be displayed and/or printed with formatted advertisement 108. Store 58 may have the option of filtering display or printing of formatted advertisement 110.

Advertisement 110 may include a telephone number to interactive call center 98. Customer 52 may call interactive call center 98, and enter the advertisement ID 108 and/or the ticket number shown on formatted advertisement 110. Interactive call center 98 may then consult business intelligence warehouse 94 for the name and telephone number of the advertiser 74 corresponding to the advertisement 108. Adaptive learning server 88 may be informed of the telephone request to enable self-tuning of adaptive learning server 88. Business intelligence warehouse 94 may keep a record of the telephone call.

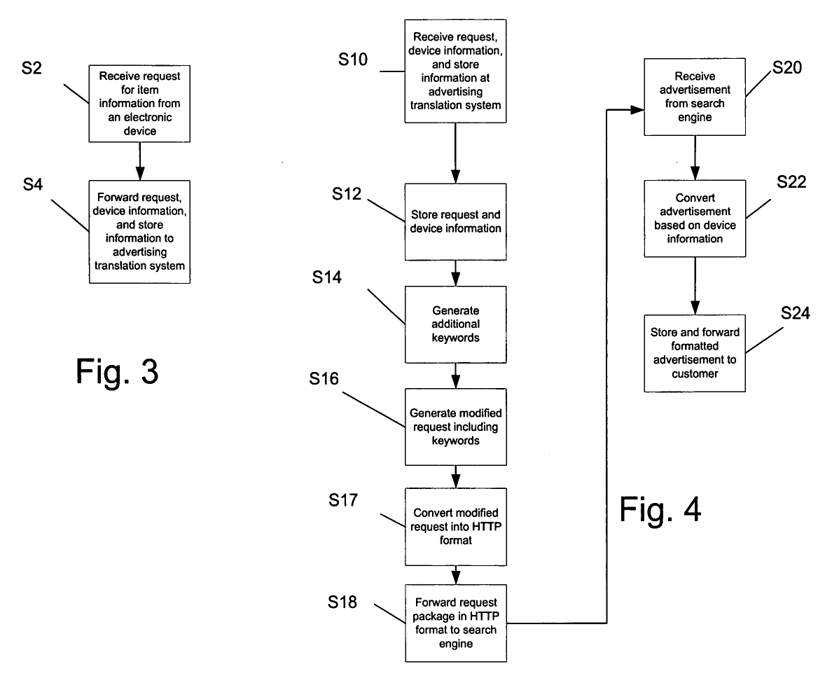

A flow chart describing a process which could be performed in accordance with an embodiment of the invention is shown in FIGS. 3 and 4. The process shown in FIGS. 3 and 4 could be implemented using, for example, system 50. As shown, at step S2, an advertising system receives a request for item information from an electronic device. At step S4, the request, device information, and store information are forwarded to an advertising translation system.

At step S10 in FIG. 4, the request, device information, and store information are received by the advertising translation system. At step S12, the request, device information and store information are stored. At step S14, additional keywords are generated for the request. At step S16, the system generates a modified request including keywords. At step S17, the modified request is converted into HTTP format. At step S18, the request in HTTP format is forwarded to a search engine. At step S20, the system receives at least one advertisement from the search engine based on the request. At step S22, the system converts the advertisement based on the device information into a formatted advertisement. At step S24, the formatted advertisement is stored and forwarded to a customer.

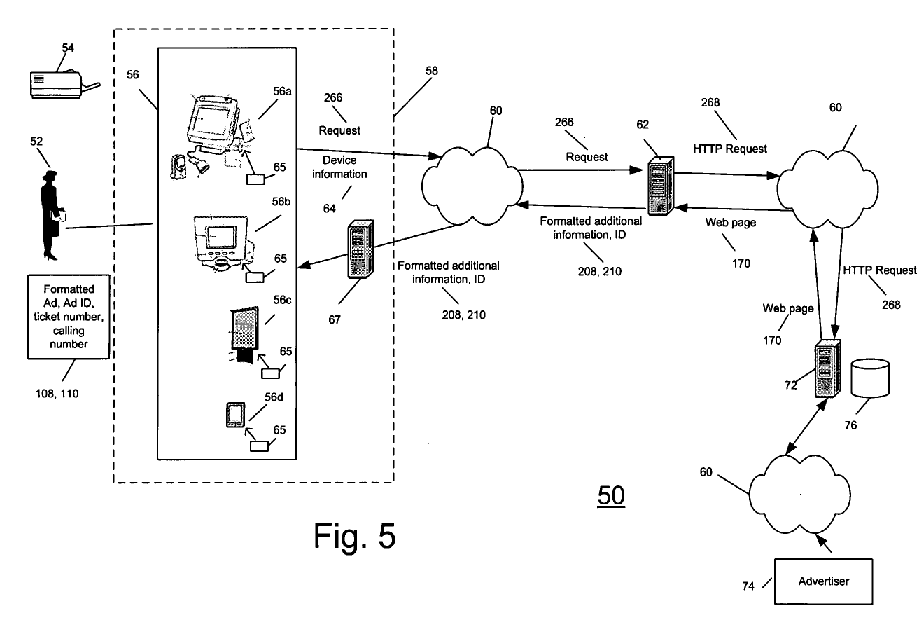

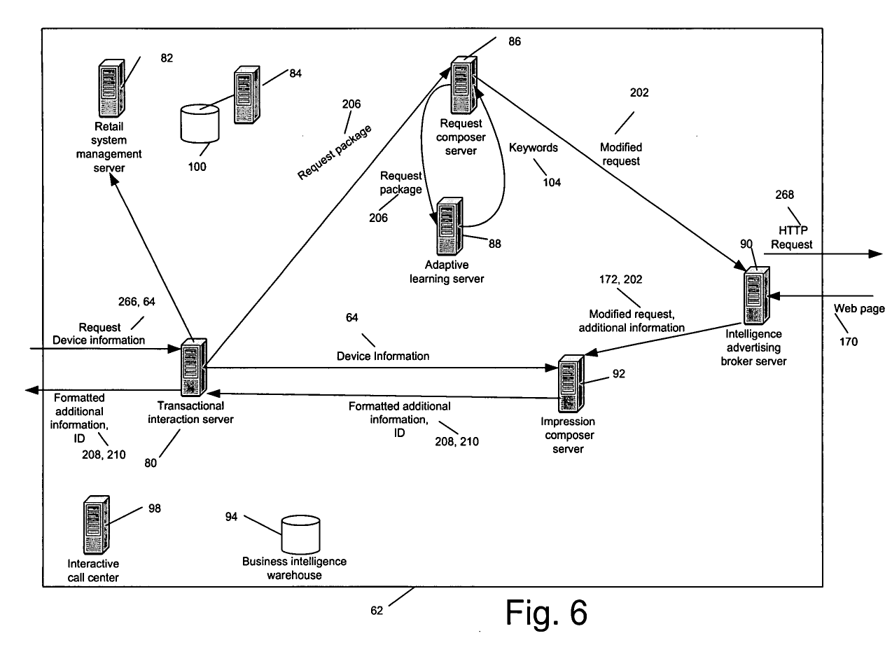

Referring to FIG. 5, customer 52 may interact with formatted advertisement 110, such as by clicking on electronic device 56c, to receive more information about item 54. For example, customer 52 may interact with formatted advertisement 110 causing software 65 to generate and forward a request 266 including information about formatted advertisement 110, advertisement ID 108, and device information 64 to advertising translation system 62. Similarly, customer 52 may use telephone 56d to generate request 266 in the form of a text message displayed on formatted advertisement 110. Referring to FIG. 6, upon receipt of request 266 transactional interaction server 80 may check security codes to ensure that electronic device 56 is authorized to use system 50. Transactional interaction server 80 may assign a unique ticket number to request 266 and store a record of request 266 in business intelligence warehouse 94 including date and time, ticket number, store 58 ID and request 266.

If device information 64 is not received from electronic device 56 or store 58, transactional interaction server 80 may obtain device information 64 from retail system management server 82 etc. Transactional interaction server 80 converts request 266 into request package 206 in XML format including, for example, the ticket number, store ID, identification of store 58, and request 266, and sends request package 206 to request composer server 86.

Request composer server 86 queries business intelligence warehouse 94 for the identity of the particular internet based online advertising server 72 and the URL of advertiser 72 that provided formatted advertisement 110. Business intelligence warehouse 94 processes the request and returns the requested information. Request composer server 86 updates adaptive learning server 88 because customer 52 expressed interest in formatted advertisement 110 and then sends a modified request 202 to intelligence advertising broker server 90 requesting additional information regarding advertisement ID 108 from advertiser 74.

As customer 52 selected an advertised item, he has expressed his interest regarding the advertised item. The collected information regarding the customers' interests allows adaptive learning server 88 to identify the keywords 104 that have been used for the advertised items. For example, adaptive learning server 88 may give a higher effectiveness rank or score to these keywords and use these particular keywords more often for similar items. Adaptive learning server 88 also analyses formatted advertisement 110 to discover new keywords 104 that can be added to an item's dependency tree. This operation means that displayed or printed ads could be different even for the same item 54.

Intelligence advertising broker server 90 converts modified request 202 to an HTTP request 268 corresponding to modified request 202. HTTP request 268 is sent to the URL of advertiser 72 relating to formatted advertisement 110. Intelligence advertising broker server 90 may notify the internet based online advertising server 72 that provided advertisement 70 of HTTP request 268.

Intelligence advertising broker server 90 receives web page 170 from advertiser 72. Intelligence advertising broker server 90 parses page 170 and extracts additional information 172 related to advertisement 70.

Intelligence advertising broker 90 sends the combination of additional information 172 and modified request 202 to impression composer server 92. Impression composer server 92 converts additional information 172 to formatted additional information 210 in a format that is suitable for electronic device 56 to display or print. Impression composer server 92 assigns a unique ID number 208 to each formatted additional information 210. Impression composer server 92 stores advertisement ID number 208 and formatted additional information 210 in business intelligence warehouse 94 including date and time, ticket number, retail system ID, request body 266, advertisement ID 208, formatted advertisement 110, advertising server 72, web page 170 and additional information 210. Impression composer server 92 forwards formatted additional information 210 and ID number 208 to transactional interaction server 80. Transactional interaction server 80 converts and forwards formatted additional information 210 to electronic device 56 using a protocol that can be communicated over network 60. For example, if customer 52 sent a text message using a cell phone 56d, impression composer server 92 may send formatted additional information 210 as a text message. Electronic device 56 displays or prints formatted additional information 210.

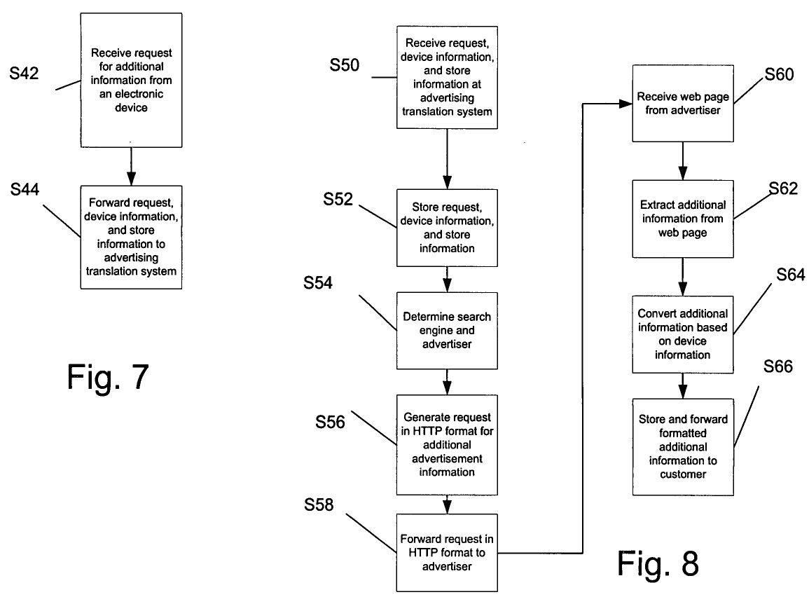

A flow chart describing a process which could be performed in accordance with an embodiment of the invention is shown in FIGS. 7 and 8. The process shown in FIGS. 7 and 8 could be implemented using, for example, system 50. As shown, at step S42, an advertising system receives a request for additional information from an electronic device. At step S44, the request, device information and store information are forwarded to an advertising translation system.

At step S50 in FIG. 8, the request and device information are received by the advertising translation system. At step S52, the request, device information and store information are stored. At step S54, the system determines the search engine and advertiser that provided the advertisement. At step S56, a request is generated in HTTP format for the additional advertisement information. At step S58, the request in HTTP format is forwarded to an advertiser. At step S60, the system receives a web page from an advertiser. At step S62, the system extracts additional information from the web page. At step S64, the system converts the additional information based on the device information. At step S66, the formatted additional information is stored and forwarded to a customer.

A system as described above thus creates opportunities for Internet based online service providers, advertisers and retail stores by extending the advertisement opportunities to the retail stores and by providing a hassle free transparent highly profitable advertising system to retail stores with low or no cost of development. Much more advertising data is available then that provided for stores with local advertising databases. It also creates unique equal opportunities for small and large, known and not well-known, business entities to advertise effectively their product or services with low cost at any stores by a click on a button from their computer.

A web site (not shown) may be provided for customers 52 to register and take advantage of extra facilities such as reviewing purchased items or items of the interest, reviewing a price comparison table, reviewing coupons and promotions, reviewing accessories information, price and reviews related to the purchased items or items that the customer is interested in. These services could also be provided through social networking platforms (e.g. FACEBOOK) as well. Once registered, a piece of software may be loaded on the customer's browser, e.g. a cookie. These cookies could be accessed by the online advertising service providers and search engines. Using cookies, search engines and online advertising service providers (e.g. GOOGLE, YAHOO!, etc.) may collect customer's retail purchasing behavior and use this information while the customer is using the Internet.

It is beneficial for the Internet-based online advertisers to collect purchase information and customers' retail interests. Advertisers can bid on advertisements based on purchased item information, purchased item history, location of the point of purchase, type of store, times of purchase, etc.

Advertisers are provided with a new location for advertisements. They can, for example, pay online advertising service providers for certain keywords so that advertisements may be displayed at retail locations. Business intelligence warehouse 94 provides a wealth of information not available in the prior art. For example, business intelligence warehouse 94 can be used for market research data. Business intelligence warehouse 94 can indicate how many items are being sold or advertisements are displayed across multiple stores.

Many advertising models may be supported by a system in accordance with the invention. For example:

Cost-Per-Click: advertiser pays a certain amount (determined bidding process) when a customer selects an advertised item on the interactive information station or interactive billboard.

Cost-Pert-Impression: advertisers pay when their advertisement content is displayed for predefined number of times (e.g. 1000 times).

Cost-Per-Print: advertisers pay when their advertisement contents including coupons and promotions are printed on the customer receipt.

Cost-Per-Call: advertiser pays when the customer contacts them by phone based on a printed phone number on the customer receipt.

Cost-Per-Sale (Cost-Per-Action): advertiser pays when the customer actually buys an advertised item that was displayed or printed prior to the purchase.

Cost-Per-Mobile Impression: advertisers pay when the customer shows interest in a specific item, or displayed or printed advertised item, by requesting information regarding the item or the advertised item on their mobile phone.

Although servers are shown and described, processors or combinations of processors and servers could be used.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A method for providing information about an item to a customer, the method comprising:
receiving a first request from an electronic device, regarding an item, at a first processor, the electronic device and the item both being disposed inside a store;
generating, at a second processor connected to the first processor, at least one keyword relating to the first request;
converting, at a third processor connected to the second processor, the keyword into a second request;
forwarding, at the third processor, the second request over the Internet to a search engine;
receiving, at the third processor, at least one advertisement from the search engine relating to the second request;
receiving, at a fourth processor connected to the third processor, device information and the advertisement;
converting, at the fourth processor, the advertisement based on the device information to produce a formatted advertisement;
receiving the formatted advertisement at the first processor; and
forwarding the formatted advertisement from the first processor to the electronic device.

2. The method as recited in claim 1, wherein the first, second, third, and fourth processors are distinct.

3. The method as recited in claim 1, further comprising
generating an advertisement ID at the fourth processor;
receiving the advertisement ID at the first processor; and
forwarding the advertisement ID from the first processor to the electronic device.

4. The method as recited in claim 1, wherein
the method further comprises:
receiving a third request, at the first processor, for additional information about the item based on the formatted advertisement;
determining an advertiser relating to the formatted advertisement;
forwarding the third request from the third processor over the Internet to the advertiser;
receiving at least one web page from the advertiser at the third processor;
extracting information from the web page at the third processor;
receiving the information at the fourth processor;
converting, at the fourth processor, the information based on the device information to produce formatted additional information;
receiving the formatted additional information at the first processor; and
forwarding the formatted additional information from the first processor to the electronic device.

5. The method as recited in claim 1, wherein:
the electronic device is a cell phone; and
the request is a text message.

6. The method as recited in claim 1, wherein:
the receiving the request includes converting the request into an XML format; and
the forwarding the formatted advertisement includes sending the formatted advertisement in an internet protocol or SMS format.

7. The method as recited in claim 1, wherein the device information is received from the electronic device.

8. The method as recited in claim 1, wherein:
the request includes a barcode for the item; and
the generating at least one keyword includes sending a query to a database including the barcode.

9. The method as recited in claim 3, further comprising storing the request, the HTTP request, the formatted advertisement, and the advertisement ID in a database.

10. A system for providing information about an item to a customer, the system comprising:
a first processor effective to receive a first request from an electronic device regarding an item, the electronic device and the item both being disposed inside a store;
a second processor connected to the first processor and effective to receive the first request and generate at least one keyword relating to the first request;
a third processor connected to the second processor and effective to receive the keyword, convert the keyword into a second request and forward the second request to a search engine;
the third processor further effective to receive least one advertisement from the search engine, the advertisement relating to the second request;
a fourth processor connected to the third processor and effective to receive device information and the advertisement, the fourth processor effective to convert the advertisement based on the device information to produce a formatted advertisement; and wherein
the first processor is effective to receive and forward the formatted advertisement to the electronic device.

11. The system as recited in claim 10, wherein the first, second, third, and fourth processors are distinct.

12. The system as recited in claim 10, wherein:
the fourth processor is effective to generate an advertisement ID; and
the first processor is effective to receive and forward the advertisement ID from the first processor to the electronic device.

13. The system as recited in claim 10, wherein
the first processor is effective to receive a third request for additional information about the item based on the formatted advertisement;
the first processor is further effective to determine an advertiser relating to the formatted advertisement;
the third processor is effective to forward the third request from the third processor over the Internet to the advertiser;
the third processor is further effective to receive at least one web page from the advertiser, and extract information from the web page;
the fourth processor is effective to receive and format the information based on the device information to produce formatted additional information; and
the first processor is effective to receive and forward the formatted additional information from the first processor to the electronic device.

14. The system as recited in claim 10, wherein:
the electronic device is a cell phone; and
the request is a text message.

15. The system as recited in claim 10, wherein:
the first processor is further effective to convert the request into an XML format; and
the first processor is effective to send the formatted advertisement in an internet protocol or SMS format.

16. The system as recited in claim 10, wherein the device information is received from the electronic device.

17. The system as recited in claim 10, wherein:
the request includes a barcode for the item; and
the second processor generates the at least one keyword by sending a query to a database including the barcode.

18. The system as recited in claim 11, further comprising a database effective to store the request, the HTTP request, the formatted advertisement, and the advertisement ID.

19. The system as recited in claim 10, further comprising:
a fifth processor effective to receive and filter the formatted advertisement before the formatted advertisement is received by the electronic device.

20. A method for providing information about an item to a customer, the method comprising:
receiving a request from an electronic device, regarding an item, at a first processor, the electronic device and the item both being disposed inside a store;
generating, at a second processor connected to the first processor, at least one keyword relating to the request;
converting, at a third processor connected to the second processor, the keyword into a request;
forwarding, at the third processor, the request over the Internet to a search engine;
receiving, at the third processor, at least one alternate price or customer review from the search engine relating to the request;
receiving, at a fourth processor connected to the third processor, device information and the advertisement;
converting, at the fourth processor, the alternate price or customer review based on the device information to produce a formatted alternate price or customer review;
receiving the formatted alternate price or customer review at the first processor; and
forwarding the formatted alternate price or customer review from the first processor to the electronic device.

21. A method for providing information about an item to a customer, the method comprising:
receiving, at a first processor, at least one keyword regarding an item from an electronic device, the electronic device and the item both being disposed inside a store;
converting, at a second processor connected to the first processor, the keyword into a request;
forwarding, at the second processor, the second request over the Internet to a search engine;
receiving, at the second processor, at least one advertisement from the search engine relating to the request;
receiving, at a third processor connected to the second processor, device information and the advertisement;
converting, at the third processor, the advertisement based on the device information to produce a formatted advertisement;
receiving the formatted advertisement at the first processor; and
forwarding the formatted advertisement from the first processor to the electronic device.

22. The method as recited in claim 1, further comprising:
receiving a telephone call from a customer relating to the formatted advertisement; and
sending a telephone number of an advertiser related to the formatted advertisement to the customer.

23. The system as recited in claim 10, further comprising:
a fifth processor effective to receive a telephone call from a customer relating to the formatted advertisement, the fifth processor further effective to send a telephone number of an advertiser related to the formatted advertisement to the customer.

24. The method as recited in claim 1, further comprising receiving the formatted advertisement at a fifth processor, and filtering the formatted advertisement before the formatted advertisement is received by the electronic device.
